(19) United States
(12) Patent Application Publication
(10) Pub. No.: US 2008/0048843 A1
(43) Pub. Date: Feb. 28, 2008

(54) Vehicle Horn

(75) Inventor: Masaki Magarisawa, Gunma (JP)

Correspondence Address: OLIFF & BERRIDGE, PLC, P.O. BOX 320850, ALEXANDRIA, VA, 22320-4850, US

(73) Assignee: Mitsuba Corporation, Kiryu-shi, Gunma (JP)

(21) Appl. No.: 10/584,939

(22) PCT Filed: Jan. 7, 2005
(86) PCT No.: PCT/JP05/00440

§ 371 Date: Jul. 5, 2006

(30) Foreign Application Priority Data
Jan. 9, 2004 (JP) 2004-004340

(51) Int. Cl. G10K 9/15

(52) U.S. Cl. 340/390.1

(57) ABSTRACT

A horn for a vehicle enabling the protection of a noise prevention member and a reduction in size, comprising the noise prevention member to eliminate noise. An outwardly projecting recessed part (2b) is formed at the bottom piece part (2a) of a bottomed cylindrical casing (2), the coil bobbin (4) of an excited coil (C) is stored in the recessed part (2b), and a terminal unit (13) having a pair of first and second terminal plates (15) and (16) for supplying power to the winding (5) of the excited coil (C) is disposed on the outer surface of the outer diameter side bottom piece (2c) of the casing. The noise prevention member (17) is disposed between the terminal plates (15) and (16) of the terminal unit (13), and a resin material (18) is filled there to embed it.

This application is the U.S. National Stage of PCT/JP2005/000440, filed Jan. 7, 2005, which claims priority from JP2004-004340, filed Jan. 9, 2004, the entire disclosures of both applications being incorporated herein by reference thereto.

### BACKGROUND

The disclosure relates to a vehicle horn that is mounted on a vehicle, such as a car, a motorcycle, or a special-purpose vehicle.

Generally, as such a vehicle horn, a vehicle horn with the following structure is known. Namely the vehicle horn has a recessed part projected outside which is formed on a bottom piece part of a cylindrical casing with a bottom, and an exciting coil which is formed by winding a winding wire around a coil bobbin and is housed in the recessed part. Provided in a cylinder of the casing is a fixed iron core, a movable iron core, which is displaced in an axial direction when being brought into contact with or separated from the fixed iron core based on excitation/non-excitation of the exciting coil, a fixed contact, and a movable contact intermittently switched based on the displacement of the movable iron coil in relation to the fixed contact or the like. Further, a terminal member, provided with a pair of terminals for supplying electric power to the exciting coil, is arranged on an outer surface of the bottom piece part of the casing. In this type of vehicle horn, a warning sound is generated based on repeated intermittent switching between the movable contact and the fixed contact. An electrical noise is also generated, by arc discharge, at the time of generating a warning sound. Such noise often has an effect on other electronic equipment. Thus, prevention of the noise has been proposed in recent years.

As an improvement, it has been proposed to prevent the noise by connecting a noise preventing member in parallel to a wiring circuit of the fixed contact, the movable contact and the exciting coil. For example, a vehicle horn having a capacitor, employed as the noise preventing member, fixed to an outer diameter part of the coil bobbin in the cylinder of the casing with a specific locking piece (Japanese Published Examined Utility Model Application No. Sho-51-22612). Another vehicle horn has been proposed miniaturizes the noise preventing member by using a varistor as the noise preventing member. The varistor is provided in the vicinity of a fixed part where a plate for the fixed contact and a plate for the movable contact, in the cylinder of the casing, are fixed in an insulation-shape (Japanese Published Unexamined Patent Application No. Hei-5-48000).

### SUMMARY

On the other hand, miniaturization of the vehicle horn has been strongly requested, and also miniaturization of the casing of the vehicle horn has been strongly demanded. However, both the vehicle horns disclosed in Japanese Published Examined Utility Model Application No. Sho-51-22612 and Japanese Published Unexamined Patent Application No. Hei-5-48000 are structured so as to provide the noise preventing member in the cylinder of the casing. Thus, it is necessary to consider the rise in temperature in the cylinder and to ensure a space for the noise preventing member. As a result, miniaturization of the casing is difficult to realize. In addition, an exclusive member for fixing the noise preventing member becomes necessary in these vehicle horns. Not only does the structure become complicated, but also the cost increases. These problems are to be solved by the invention.

The invention was made in order to solve, at least, the above problems. A vehicle horn is structured in such a manner that a recessed part projected outwardly is formed on a bottom piece part of a bottom of a cylindrical casing. A coil bobbin of an exciting coil is housed in the recessed part and a terminal member, provided with terminal plates for supplying electric power to a winding of the exciting coil, is arranged on an outer peripheral surface of the bottom piece part of the casing, and a noise preventing member is provided in the terminal member.

Thus, the inner temperature of the casing has no effect on the noise preventing member and the casing can be miniaturized.

Further, the terminal member is provided with a pair of terminal plates, and the noise preventing member is provided between the pair of terminal plates. Thus, the inner temperature of the casing has no impact on the noise preventing member and the casing can be miniaturized.

In addition, the terminal member is made as a terminal unit in which the noise preventing member is built beforehand and the terminal unit is attached to an outer diameter side part of the recessed part of the bottom piece part of the casing. Thus, assembly work can be simplified.

The terminal member is provided so not to project further outside than the recessed part of the bottom piece part of the casing. Thus, when the horn is installed, a space between it and other members can be reduced.

The noise preventing member is provided in a space formed in the terminal member and the space is filled with a resin material. Thus, the noise preventing member can be protected and reliably fixed.

Because the inner temperature of the casing has no impact on the noise preventing member, the noise preventing member can be protected. In addition, the casing can be miniaturized.

### BRIEF DESCRIPTION OF THE DRAWINGS

The disclosure will be made with respect to the drawings in which:

FIG. 1 is a partial side cross sectional view of a horn;

FIG. 2 is a front view of a state where members are attached to a casing;

FIG. 3 is a rear view of the horn;

FIG. 4(A) is a front view of a terminal unit, and FIG. 4(B) is a rear view of the terminal unit; and

FIG. 5(A) is a cross sectional view taken along line 5A-SA in FIG. 4(A), FIG. 5(B) is a plan view of FIG. 4(A), and FIG. 5(C) is a cross sectional view taken along line 5C- 5C in FIG. 4(B).

### DETAILED DESCRIPTION OF EMBODIMENTS

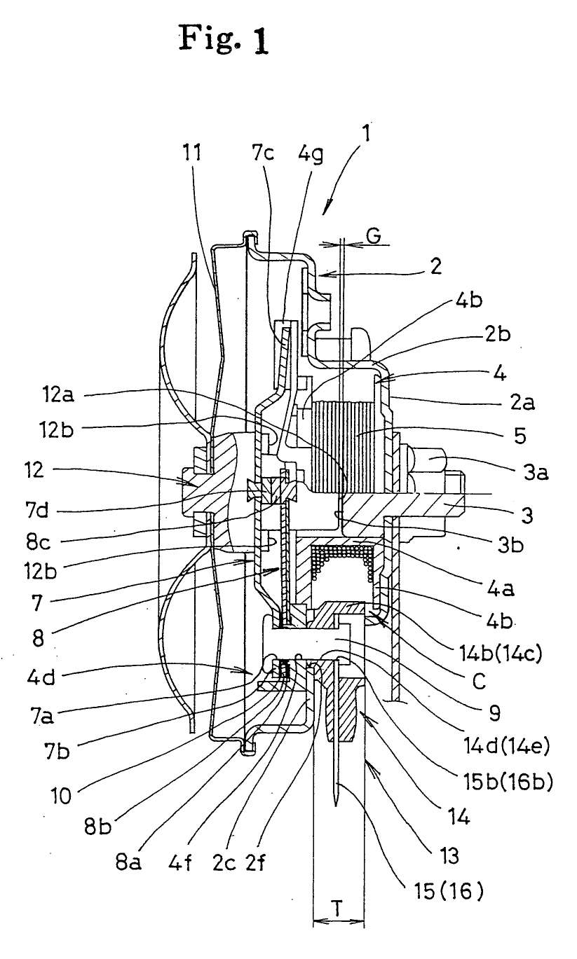

Next, an exemplary embodiment will be described hereinafter with reference to FIGS. 1 to5.

In the figures, the reference numeral 1 denotes a vehicle horn. A casing 2 for the horn 1 is formed cylindrically with a bottom. A recessed part 2b projecting outwardly is formed on the center part of a bottom piece part 2a of the casing 2 (bottom as used in the context of the casing is toward the right in FIG. 1). A fixed iron core 3 penetrates an axially center part of the recessed part 2b and is supported position-adjustably in an axial direction by a fixing nut 3a.

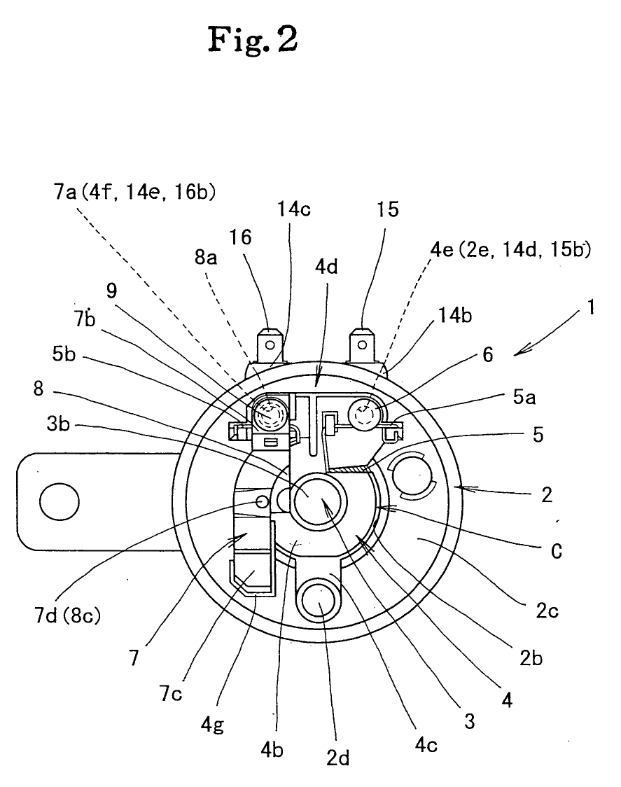

The reference numeral 4 denotes a coil bobbin. The coil bobbin 4 is composed of a cylinder 4a and flanges 4b, which are extended to outer diameter sides from both ends of the cylinder 4a, respectively, and are integrally formed with the cylinder 4a. An exciting coil C is constituted in such a manner that a winding 5 is wound around the periphery of the cylinder 4a. The coil bobbin 4 is housed in the recessed part 2b. The fixed iron core 3 is inserted into the cylinder 4a and one of the flanges 4b is supported by the bottom piece part 2a of the casing 2. Further, an attachment piece part 4c (FIG. 2) and a terminal fixing piece part 4d, which are faced to each other in radial direction and project toward an outer diameter, are integrally formed on a peripheral edge of the flange 4b of the coil bobbin 4 at the opening side of the casing 2. The attachment piece part 4c is fixed to an outer diameter side bottom piece part 2c formed at an outer diameter side of the recessed part 2b of the casing 2 via a pin 2d.

The terminal fixing part 4d is arranged at a facing part of a pair of through holes 2e, 2f opened in a circumference direction of the casing outer diameter side bottom piece part 2c. A pair of through holes 4e, 4f are opened which penetrate the casing through holes 2e, 2f respectively. An end 5a of the winding 5, constituting the exciting coil C, is pulled out and wired from the coil bobbin cylinder 4a in the vicinity of the through hole 4e of the pair of through holes 4e, 4f. As described below, a first terminal pin 6, made of a conductive member, is provided so as to penetrate coil bobbin through hole 4e and the casing through hole 2e. Therefore the winding end 5a is electrically connected to the first terminal pin 6.

Additionally, the other end 5b of the winding 5 of the exciting coil C is pulled out and wired from the cylinder 4a in the vicinity of the coil bobbin through hole 4f. Further, a base end 7b of a fixing plate 7, which is constituted by the conductive plate member and in which a through hole 7a is opened, and a base end 8b of a movable plate 8, which is constituted by the conductive plate member and in which a through hole 8a is opened, are provided in alignment with the through hole 4f. A second terminal pin 9, made of a conductive member, is provided so as to penetrate the coil bobbin 4 through hole 4f which is partly defined by a lip, the fixing plate through hole 7a, the movable plate through hole 8a and the casing through hole 2f, respectively. Therefore, the fixing plate 7 is electrically connected to the second terminal pin 9 and the movable plate 8 is insulated from the second terminal pin 9 by the lip of the coil bobbin 4 which lies between the movable plate 8 and the second terminal pin 9. The movable plate 8 is electrically connected to the other winding end 5b. In addition, an insulating material 10 is interposed between the fixing plate 7 and the movable plate 8, and therefore the fixing plate 7 is insulated from the movable plate 8. Moreover, a top end 7c (top and bottom used in the context of the plates 7, 8 refer to the portrayal in FIG. 1) of the fixing plate 7 is fixed by a fixing piece 4g extended from the flange 4b of the coil bobbin 4 at the opening side of the casing 2.

A fixed contact 7d is formed on the fixing plate 7 so as to project toward the movable plate 8 side, a movable contact 8c, facing the fixed contact 7d, is formed on the movable plate 8 so as to project toward the fixing plate 7 side. The movable contact 8c is brought into contact with and electrically connected to the fixed contact 7d in the natural state. Thus, when electric power is supplied via the first and second terminal pins 6, 9 in the contact state, electric power is supplied to the exciting coil C.

A peripheral edge of a diaphragm 11 is integrally fixed to an opening edge of the casing 2, and a long shaft-shaped movable iron core 12 is integrally provided at the center of the diaphragm 11. An end surface 12a of the movable iron core 12 is arranged so as to adjacently face an end surface (inside top end surface) 3b of the fixed iron core 3 inside the casing 2 with a predetermined gap G. Further, as described above, the exciting coil C is supplied with the electric power to magnetize the fixed iron core 3 so that the movable iron core 12 is attracted to the fixed iron core 3 based on the flexibility of the diaphragm 11 and displaced.

A step 12b is formed on a peripheral surface of the movable iron core 12. The step 12b forcibly displaces the movable plate 8 in a direction where it moves away from the fixed plate 7, based on the displacement of the movable iron core 12 toward the fixed iron core 3 side, and causes the movable contact 8c move away from the fixed contact 7d. In this state, the exciting coil C is not energized and degaussed.

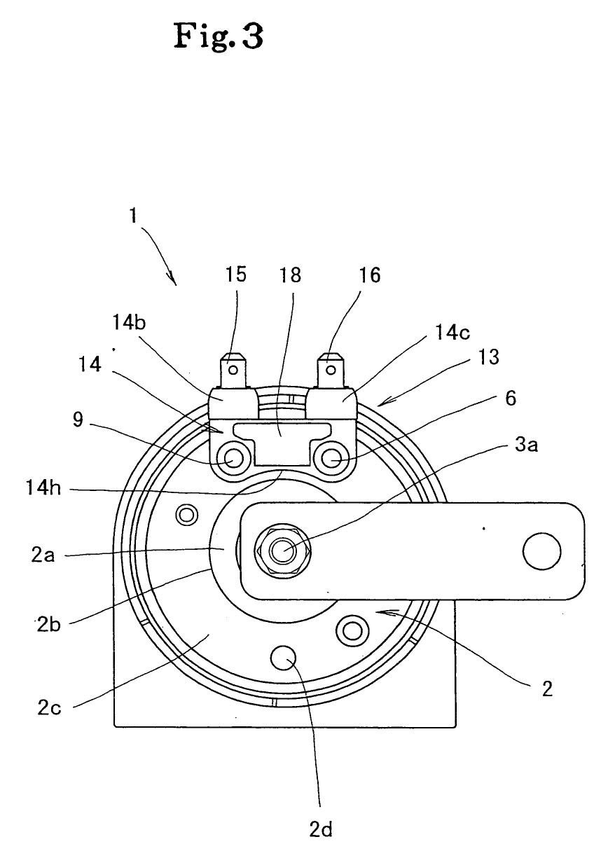

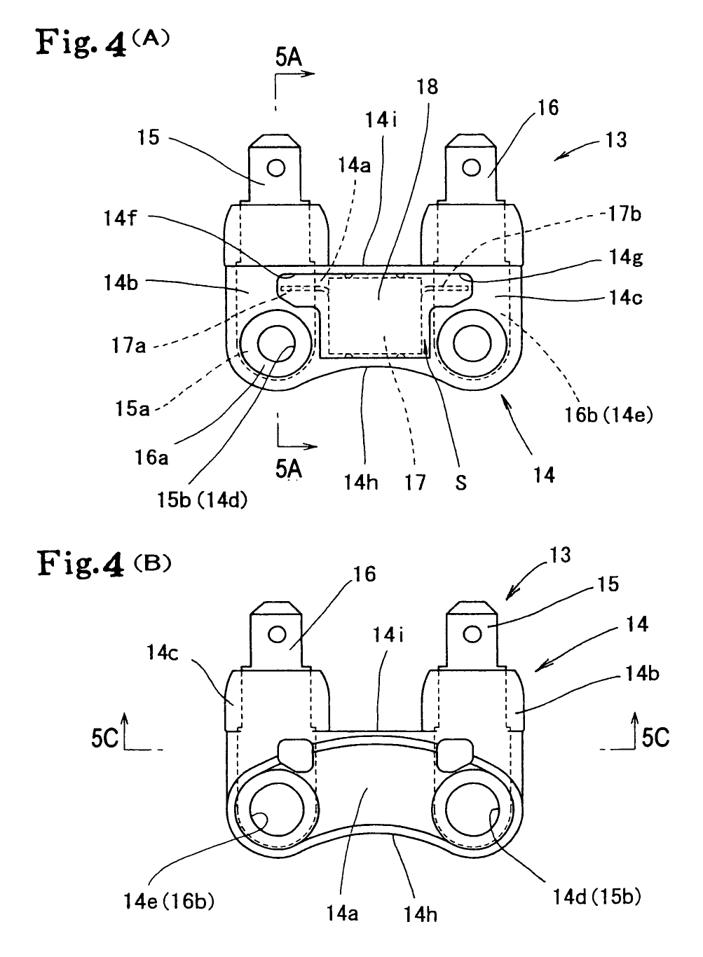

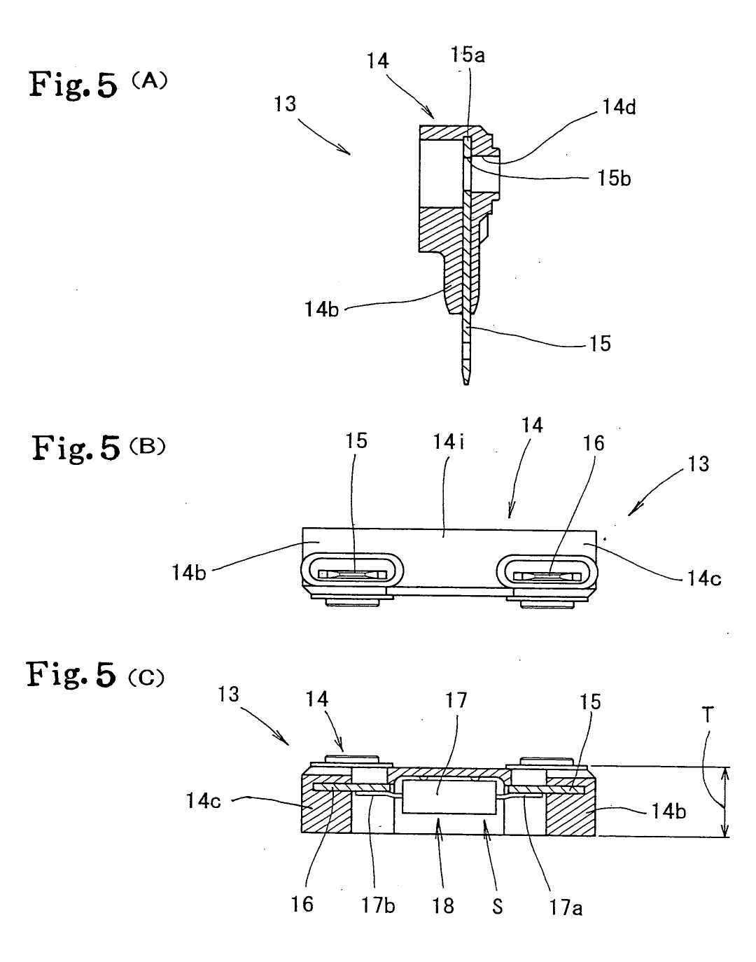

Reference numeral 13 denotes a terminal unit (corresponding to the terminal member in this disclosure) in which penetrating top ends of the first and second terminal pins 6, 9, projecting toward the outer surface of the casing outer diameter side bottom piece part 2c, are housed. A case body 14 (FIGS. 3-5(c)), constituting the terminal unit 13, includes a bottom piece 14a along the casing outer diameter side bottom piece part 2c. The case body 14 is formed in a box-shape, and a space S is formed between side pieces 14b, 14c provided at both sides of the case body 14 in the circumferential direction of the casing 2. Base ends 15a, 16a of the first and second terminal plates (corresponding to a pair of terminal plates of the present invention) 15, 16 are positioned within the side pieces 14b, 14c respectively. A pair of through holes 14d, 14e respectively formed in the side pieces 14b, 14c are provided so as to respectively communicate with through holes 15b, 16b respectively formed in the base ends 15a, 16a. The penetrating top ends of the first and second terminal pins 6, 9 penetrating from the inside of the casing 2 penetrate the through holes 14e, 14f and the through holes 15b, 16b respectively. Thus, the first and second terminal pins 6, 9 are electrically connected to the first and second terminal plates 15, 16 respectively.

A capacitor 17, which is a noise preventing member, is housed in the space S formed between the side pieces 14b, 14c of the case body 14. A pair of connecting lines 17a, 17b extended from the capacitor 17 are electrically connected to the first and second terminal plates 15, 16 exposed outside via notches 14f, 14g respectively formed in the side pieces 14b, 14c so as to communicate with the space S, respectively, by means of such as soldering. Thus, the noise preventing member 17 is arranged in such wiring state as to be connected to a contact part of the fixed contact 7d and the movable contact 8c in parallel.

The space S, in which the noise preventing member 17 is provided, is then filled with an insulating resin material 18, and thus the noise preventing member 17 is encased by the resin material 18.

With the structure described above, the terminal unit 13 is attached to the casing 2 in the following manner. Namely, the bottom piece 14a is brought into contact with the casing outer diameter side bottom piece part 2c, the resin material 18 filling side is exposed to the outside (or right side in FIG. 1), the first and second terminal pins 6, 9 projecting outwardly (to the right side of FIG. 1) from the casing outer diameter side bottom piece part 2c are inserted into the casing through holes 14d, 14e and the first and second terminal plate through holes 15b, 16b respectively, and the penetrating ends of the first and second terminal pins 6, 9 are caulked. By this attachment, the casing 2, the coil bobbin 4, the fixing plate 7, the movable plate 8, the one winding end 5a and the other winding end 5b are electrically connected to each other as described above and integrally fixed. The first and second terminal pins 6, 9 are electrically connected to the first and second terminal plates 15, 16 respectively, and the terminal unit 13 is integrally fixed to the casing 2 by one caulking operation.

Here, a side piece (inner radial side piece) 14h at an inner radial side of the case body 14 is formed in an arc-shape so as to adjacently face the peripheral surface of the casing recessed part 2b. The thickness T of the case body 14 in an axial direction (the thickness in a box depth direction) is set so as to be smaller than the projecting amount of the casing recessed part 2b. The terminal unit 13 is set so as to not project further than the bottom piece part 2a when attached to the casing.

Moreover, ends of the first and second terminal plates 15, 16 project toward the outer radial side from a side piece 14i at the outer radial side of casing body 14. An outer coupler (not shown) is fitted with the projecting part. Electric power is supplied to the first and second terminal pins 6, 9 via the first and second terminal plates 15, 16 from the outside and is sent to the exciting coil C.

In the horn 1 thus structured, when the switching operation (not shown) is performed, the electric power is supplied to the first and second terminal pins 6, 9, the exciting coil C is energized and excited via the fixed contact 7d and the movable contact 8c being brought into contact with each other, and the movable iron core 12 is displaced toward the fixed iron core 3 side. Thus, the movable contact 8c moves away from the fixed contact 7d, and the exciting coil C no longer is energized. Then the movable iron coil 12 moves away from the fixed iron core 3, and the movable contact 8c again comes into contact with the fixed contact 7d and the exciting coil C is excited. A warning sound is generated by repeating this operation.

As described above, in the embodiment structured as the above, when the electric power is supplied to the first and second terminal pins 6, 9 via the first and second terminal plates 15, 16 based on the switching operation (not shown), an intermittent switching between the fixed contact 7d and the movable contact 8c is repeated and the warning sound is generated. In this case, because the noise preventing member 17 is connected to the fixed contact 7dand movable contact 8c in parallel, the noise due to the repeated intermittent switching between the fixed contact 7d and the movable contact 8c is prevented and a horn 1 having excellent performance can be obtained.

In this case, the noise preventing member 17 is not provided in the cylinder of the casing 2, but is housed in the terminal unit 13 which is provided outside of the casing 2 in order to supply the electric power. Thus, the noise preventing member 17 is not affected by the atmospheric temperature in the casing 2 and is protected based on its own heat resistance to temperature. Further, it is unnecessary to ensure an exclusive space in the cylinder of the casing 2 for the noise preventing member so that the casing can be miniaturized. Furthermore, it is unnecessary to provide an exclusive member for attachment of the noise preventing member, the structure inside the cylinder of the casing 2 can be simplified, and cost can be reduced.

Additionally, because the noise preventing member 17 is provided in the space S between the terminal plates 15, 16 which are arranged in the circumferential direction with the predetermined gap beforehand, it is unnecessary to provide additional space for the noise preventing member 17.

Additionally, because the noise preventing member 17 can be built in the terminal unit 13 together with the first and second terminal plates 15, 16, in the state where the first and second terminal plates l5, 16 are already wired, enabling the terminal unit 13 to be attached to the casing 2, the wiring of the noise preventing member 17 and assembling work are simplified, and the horn 1 can be effectively manufactured.

Additionally, because the thickness of the terminal unit 13 in the axial direction is set so as to not be larger than the projecting amount of the recessed part 2b of the casing 2, there is no problem such that the space for provision of the horn 1 is enlarged by the terminal unit 13. As a result, the space between the horn 1 and members provided in the vicinity can be reduced when the horn 1 is provided.

Further, the noise preventing member 17 is provided in the space S formed between encased parts, which face each other, of the first and second terminal plates 15, 16 of the terminal unit 13. The space S is filled with the resin material 18 so that the noise preventing member 17 is encased in and integrally fixed to the terminal unit 13. Thus, the noise preventing member 17 can be protected, a problem such as the noise preventing member 17 falling off as a result of vibration is avoided, and the noise preventing member 17 can be reliably fixed.

Additionally, when forming a product in which the noise preventing member 17 is to be provided and a product in which the member 17 is not to be provided, it is only required to prepare the terminal unit 13 in which the noise preventing member 17 is included and the terminal 13 in which the member 17 is not included. That is, the specification of the casing 2 side does not vary for each product. Thus, components can be made in common and low-cost can be realized. In addition, quality management can be simplified. Further, when the terminal unit 13 in which the noise preventing member 17 is included and the terminal 13 in which the member 17 is not included are formed, it is only required to form two types of terminal units of which the shapes of the parts exposed outside are different from each other. Thus, it is not necessary to attach identifying marks to identify whether the horn is provided with the noise preventing member or the horn is not provided with the noise preventing member and distinguishing the two different terminal units is easy.

Moreover, the disclosure, as a matter of course, is not limited to the above described exemplary embodiment. One sheet of a terminal plate is provided in the terminal member in the case of a horn in which a body ground is performed. However, even in this case, a space can be provided adjacently to the terminal plate, the noise preventing member can be built in the space, and the space can be filled with the resin material. Thus, similar to the above described exemplary embodiment, the noise preventing member can be protected against the atmospheric temperature, etc., and can be reliably fixed or positioned.

As described above, a vehicle horn according to the disclosure serves as a horn that is mounted on a general-purpose type vehicle such as a car and a motorcycle, a special-purpose vehicle or the like, and is, in particular, suitable for the general-purpose type vehicle.

1. A vehicle horn, comprising:
a cylindrical casing;
a recessed part projects outwardly from a bottom piece part of the cylindrical casing;
a coil bobbin of an exciting coil housed in the recessed part;
a terminal member, provided with terminal plates for supplying electric power to a winding of the exciting coil, arranged on an outer peripheral surface of the bottom piece part of the cylindrical casing; and
a noise preventing member provided in the terminal member.

2. The vehicle horn according to claim 1, wherein the terminal member includes a pair of terminal plates, and the noise preventing member is provided between the pair of terminal plates.

3. The vehicle horn according to claim 1, wherein the terminal member is made as a terminal unit in which the noise preventing member is built beforehand, and the terminal unit is attached to radially outer peripheral surface of a recessed part of the bottom piece part of the casing.

4. The vehicle horn according to claim 1, wherein the terminal member is provided so as not to project further outwardly than the recessed part of the bottom piece part of the casing.

5. The vehicle horn according to claim 1, wherein the noise preventing member is provided in a space formed in the terminal member, and the space is filled with a resin material.

6. The vehicle horn according to claim 2, wherein the terminal member is made as a terminal unit in which the noise preventing member is built beforehand, and the terminal unit is attached to a radially outer peripheral surface of a recessed part of the bottom piece part of the casing.

7. The vehicle horn according to claim 2, wherein the terminal member is provided so as not to project further outwardly than the recessed part of the bottom piece part of the casing.

8. The vehicle horn according to claim 3, wherein the terminal member is provided so as not to project further outwardly than the recessed part of the bottom piece part of the casing.

9. The vehicle horn according to claim 6, wherein the terminal member is provided so as not to project further outwardly than the recessed part of the bottom piece part of the casing.

10. The vehicle horn according to claim 2, wherein the noise preventing member is provided in a space formed in the terminal member, and the space is filled with a resin material.

11. The vehicle horn according to claim 3, wherein the noise preventing member is provided in a space formed in the terminal member, and the space is filled with a resin material.

12. The vehicle horn according to claim 4, wherein the noise preventing member is provided in a space formed in the terminal member, and the space is filled with a resin material.

13. The vehicle horn according to claim 6, wherein the noise preventing member is provided in a space formed in the terminal member, and the space is filled with a resin material.

14. The vehicle horn according to claim 7, wherein the noise preventing member is provided in a space formed in the terminal member, and the space is filled with a resin material.

15. The vehicle horn according to claim 8, wherein the noise preventing member is provided in a space formed in the terminal member, and the space is filled with a resin material.

16. The vehicle horn according to claim 9, wherein the noise preventing member is provided in a space formed in the terminal member, and the space is filled with a resin material.

17. An electric terminal member for a vehicle horn having a stepped cylindrical casing including a first step and a second step, the first step having a smaller diameter than the second step and receiving therein a coil bobbin, comprising:
a case body having:
a bottom piece; and
a pair of side pieces, a side piece on each side of the bottom piece and extending beyond the bottom piece in one direction;
a pair of terminals, a terminal mounted in each side piece; and
a noise preventing member mounted in a recess in the bottom piece and electrically connected to each terminal, wherein the bottom piece and the pair of side pieces define a concave surface on a side opposite to the one direction.

18. The electric terminal member according to claim 17, wherein the concave surface is complementary to the first step.

19. The electric terminal member according to claim 18, wherein a thickness of the case body is less than or equal to a depth of the first step.

20. The electric terminal member according to claim 17, wherein the recess, after the noise preventing member is mounted therein, is filed with a resin material.
